(19) United States
(12) Patent Application Publication
(10) Pub. No.: US 2009/0089148 A1
(43) Pub. Date: Apr. 2, 2009

(54) SYSTEM AND METHOD FOR PROVIDING PROMOTIONS

(75) Inventors: Vineel Chandrakanth Gujjar, Bangalore (IN); Debasis Bal, Bangalore (IN); Gopi Subramanian, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/140,541

(22) Filed: Jun. 17, 2008

(30) Foreign Application Priority Data
Sep. 27, 2007 (IN) 2186/CHE/2007

(51) Int. Cl. G06Q 30/00

(52) U.S. Cl. 705/10; 705/21; 705/14

(57) ABSTRACT

A technique is provided for delivering promotions to a consumer. The technique includes acquiring consumer identification and/or transaction data traversing via a PoS terminal over a communication channel, and generating one or more promotions to be offered to the consumer based on the acquired data. The technique further includes sending a promotional data containing the one or more generated promotions to the terminal over the communication channel.

### CROSS REFERENCE TO RELATED APPLICATIONS

This application claims the benefit of a priority under 35 USC §119 to Indian Patent Application 2186/CHE/2007, filed Sep. 27, 2007, entitled “SYSTEM AND METHOD FOR PROVIDING PROMOTIONS,” the entire contents of which is hereby incorporated by reference. This application is also related to U.S. patent application Ser. No. 11/612,834 and U.S. patent application Ser. No. 11/612,843, both filed on Dec. 19, 2006, which are incorporated herein in their entirety by reference.

### BACKGROUND

The invention relates generally to a technique of providing promotions to a consumer and, more particularly, to a technique of providing promotions at legacy point of sale (PoS) system.

In a retail environment, a point of sale (PoS) system typically includes one or more PoS terminals at the checkout counter and a centrally located PoS controller or server. The transactions occur at PoS terminals and are then communicated to the PoS controller for storage and processing. For example, as shown in FIG. 1, a conventional PoS system 10 includes PoS terminals 12 communicatively coupled to the PoS controller or server 14. Each of the terminals 12 has attached peripheral devices 16 for recording transactions. The sales transactions are first fed into the PoS terminal 12. The terminal 12 then transfers the sales information to the PoS controller 14 over the communication network 18. The PoS controller 14 stores the transactions in a transaction database 20. Additionally, the PoS terminal may process the transaction information for accounting, maintaining records, or other purposes.

While traditional PoS systems were primarily intended for tracking and record keeping of sales, there is considerable interest in offering promotions and discounts to customers based on certain parameters such as sales volume. Such promotional schemes are expected to encourage sales and ultimately increase profits. Current techniques to offer promotional schemes at PoS terminals include rewriting the PoS software with promotional schemes built-in. However, this software rewrite can be expensive and intrusive to existing operations.

It is therefore desirable to provide an efficient and cost-effective technique for delivering promotional offers to the consumer so as to increase the sales and revenue without interfering with the existing PoS infrastructure.

### BRIEF DESCRIPTION

Briefly, in accordance with one aspect of the technique, a system is provided for delivering promotions to a consumer. The system includes data acquisition circuitry communicatively coupled to a PoS communication channel and configured to acquire consumer identification or transaction data traversing via a PoS terminal. The system further includes a processor configured to generate one or more promotions to be offered to the consumer based on the acquired data.

In accordance with another aspect of the technique, a system is provided for delivering promotions to a consumer. The system includes data acquisition circuitry communicatively coupled to a communication channel between at least one of a peripheral device and a transaction terminal or the transaction terminal and a transaction server. The data acquisition circuitry is configured to acquire consumer identification or transaction data traversing over the communication channel. The system further includes a processor configured to generate one or more promotions to be offered to the consumer based on the acquired data.

In accordance with a further aspect of the technique, a point of sale (PoS) system is provided. The PoS system includes a PoS terminal configured to acquire consumer identification or transaction data through one or more peripheral devices and to transfer the acquired data to a PoS controller over a communication channel. The PoS system further includes a promotion subsystem communicatively coupled to the communication channel and configured to acquire the consumer identification or transaction data traversing over the communication channel and to generate one or more promotions to be offered to the consumer based on the acquired data.

In accordance with an additional aspect of the technique, a method is provided for delivering promotions to a consumer. The method provides for acquiring consumer identification or transaction data traversing via a PoS terminal over a communication channel, and generating one or more promotions to be offered to the consumer based on the acquired data. Systems and computer programs that afford such functionality may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of a conventional PoS system;

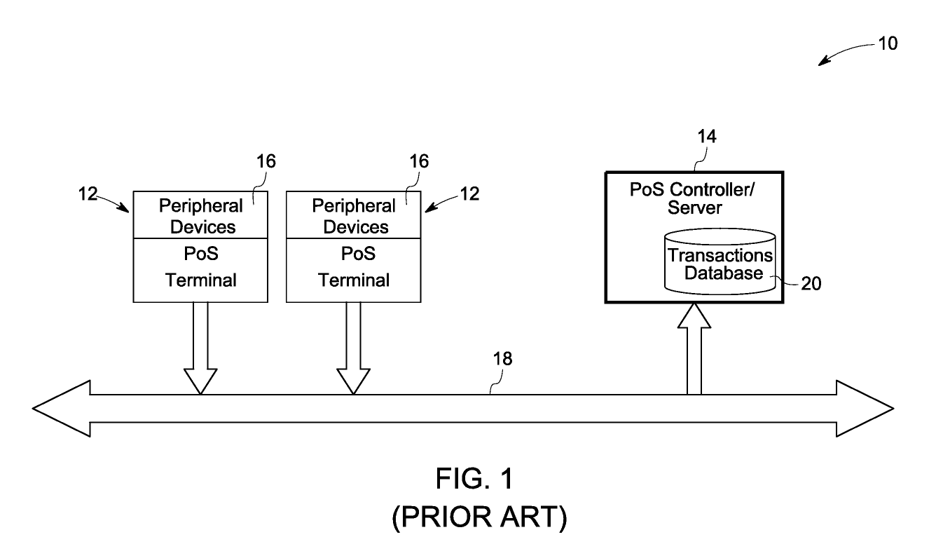

FIG. 2 is a schematic of a system for delivering promotions or offers to the consumers in accordance with aspects of the present technique;

FIG. 3 is a schematic of a general-purpose computer system adapted to act as different components of the system of FIG. 2; and

FIG. 4 is a flowchart illustrating an exemplary business process for delivering promotions or offers to the consumer in accordance with aspects of the present technique.

### DETAILED DESCRIPTION

The present techniques are generally directed to providing marketing and/or promotional offers to a consumer and to delivering the same to the consumer. Such promotion and delivery techniques may be useful in a variety of contexts, such as retail outlets, banking companies, airlines industries, hotel industries, and others. Though the present discussion provides examples in context of retail outlets, one of ordinary skill in the art will readily apprehend that the application of these techniques in other contexts, such as for airlines, hotel industries or banking companies, is well within the scope of the invention.

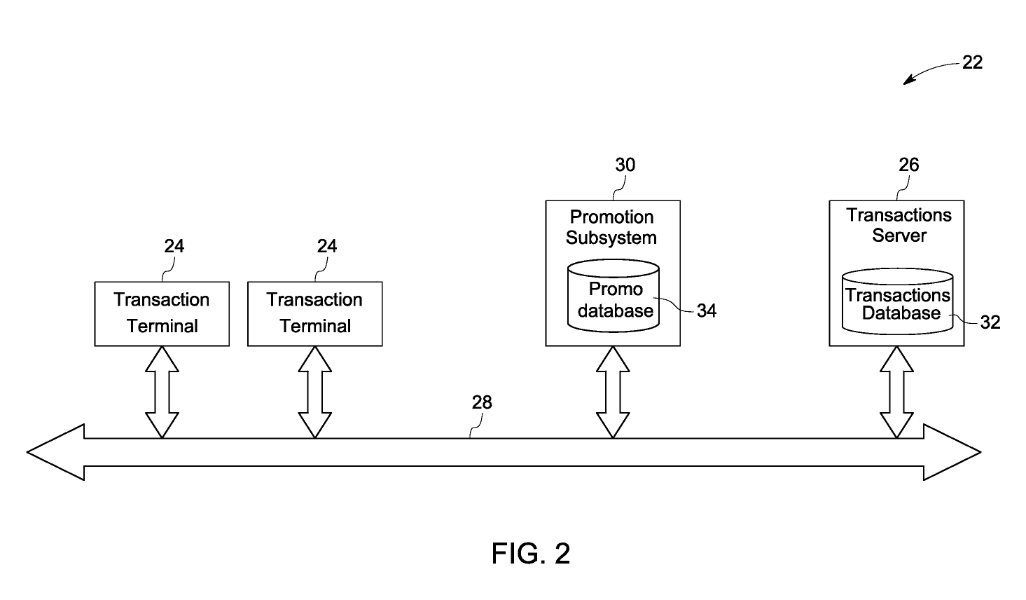

Referring now to FIG. 2, a schematic diagram of an exemplary system 22 for delivering promotions or offers to the consumers is illustrated in accordance with one aspect of the present technique. The system 22 includes a transaction terminal 24 in communication with a transaction server 26 via a secured communication channel 28. It should be noted that the terminal may be a PoS terminal, a kiosk, a portable device, an ATM, or a computer terminal. The transaction server 26 may be a PoS controller, a transaction bank server, or a merchant server. The secured communication channel 28 may be a wired or a wireless communication network such as Internet, local area network (LAN), wide area network (WAN), transaction network and so forth. Alternatively, the secured communication channel 28 may include a data pathway (e.g., data transfer buses) at the transaction terminal 24 or the transaction server 26 such as a serial bus, a parallel bus, a PCI (peripheral component interconnect) bus, and so forth. In certain embodiments, the data pathway may also include data cables connecting one or more peripheral devices and the transaction terminal 24 or transaction server 28 such as RS232 cable, USB cable and so forth.

The system 22 further includes a promotion subsystem 30 communicatively coupled to the secured communication channel 28 for generating promotional offers. In one embodiment, the promotion subsystem may be a promotion server communicatively coupled to the communication network (e.g., PoS LAN). Alternatively, the promotion subsystem 30 may be a promotion microcontroller communicatively coupled to the data pathway (e.g., PCI bus, RS232 cable). The promotion subsystem 30 monitors data traffic on the communication channel 28, acquires the data traversing the communication channel 28 upon detecting the data traffic, and processes the data to generate promotional offers. The transmission of information between the transaction terminal 24, the transaction server 26, and the promotion subsystem 30 may be in real time. It should be noted that the transaction server 26 may store the consumer identification details along with the associated transactions in a transaction database 32 for record keeping and other purposes. Similarly, the promotion subsystem 30 may host a promotion database 34 where the consumer identification details along with one or more promotions offered to the respective consumer may be stored for record keeping and other purposes.

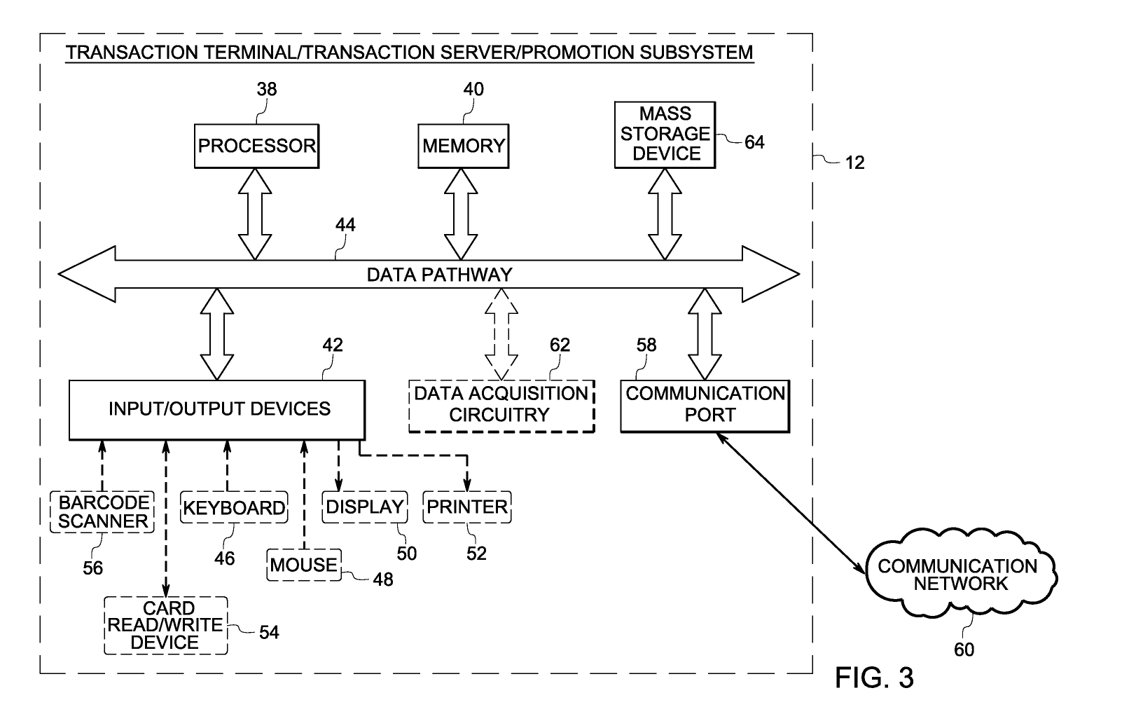

FIG. 3 illustrates a schematic diagram of a general-purpose computer system 36. As will be appreciated by those skilled in the art, the computer 36 may be adapted to function as the transaction terminal 24, the transaction server 26, or the promotional subsystem 30. The computer 36 may generally include a processor 38, a memory 40, and input/output devices 42 (also referred as peripheral devices) connected via a data pathway (e.g., buses, cables and so forth) 44. The processor 38 accepts instructions and data from the memory 40 and performs various data processing functions of the computer 32. These data processing functions may include extracting one or more promotions from a promotional data sent by the promotion subsystem 30 at the terminal end, deciphering the transaction terminal to transaction server protocol for interpreting details of the acquired data at the promotion subsystem end, generating one or more promotions at the promotion subsystem end, analyzing consumer behavior via an analytics engine at promotion subsystem end, executing instructions, and so forth as will be discussed further below. The processor 38 includes an arithmetic logic unit (ALU) that performs arithmetic and logical operations, and a control unit that extracts instructions from memory 40 and decodes and executes them, calling on the ALU when necessary.

The memory 40 stores a variety of data computed by the various data processing functions of the computer 36 or received from the input/output devices 42. The data may include, for example, transaction card data, transaction data, transaction approval data, and promotional data related to the consumer and so forth. The memory 40 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory preferably contains an operating system, which executes on the processor 38. The operating system performs basic tasks that include recognizing input, sending output to output devices, keeping track of files and directories and controlling various peripheral devices. The information in the memory 40 might be conveyed to a human user through the input/output devices 42, the data pathway 44, or in some other suitable manner.

The input/output devices 42 may include a keyboard 46 and a mouse 48 that enables a user to enter data and instructions into the computer 36. Additionally, the input/output devices 42 may include a display device 50 that enables the user to view the available information and a printer 52 that enables the user to print any data for his reference. Further, the input/output devices 42 at the transaction terminal 24 enable the transaction terminal 24 to acquire consumer identification and/or transaction data. In particular, the input/output device 42 may include a card read/write device 54 configured to read information from a transaction card and to write information on the transaction card when the transaction card is swiped or presented to the terminal 24. The input/output devices 42 at the terminal 24 may further include a barcode scanner 56 for scanning the barcode from the product, thereby acquiring the information related to the product.

The computer 36 may further include a communication port 58 such as a telephone, cable or wireless modem; a network card such as an Ethernet adapter, local area network (LAN) adapter, integrated services digital network (ISDN) adapter, or Digital Subscriber Line (DSL) adapter; a USB port; IEEE 1394 port; and so forth, that enables the computer 36 to access other computers and resources on the communication network 60. In particular, the communication port 58 enables the transaction terminal 24, the transaction server 26 and the promotion subsystem 30 to access each other over the communication network 60.

The computer 36 may also include data acquisition circuitry 62 for acquiring data traversing over the communication channel (communication network 60 and/or the data pathway 44). As will be appreciated by those skilled in the art, the data acquisition circuitry may employ any packet sniffing technologies to acquire the data being transferred over the communication channel. In one embodiment, sniffer cards may be employed based on the communication channel to which the data acquisition circuitry is plugged (e.g., PCI sniffer card on the PoS terminal PCI bus). In particular, the promotion subsystem 30 is configured to acquire consumer identification data and transaction data traversing over the communication channel through the data acquisition circuitry 62. Additionally, the data acquisition circuitry may be configured to constantly monitor data traffic over the communication channel. Thus, the data acquisition circuitry 62 acquires data packets containing consumer identification and/or transaction details upon detecting the data traffic on the communication channel. Moreover, in certain embodiments, the promotion subsystem 30 may receive data from the transaction terminal 24 and relay it to the transaction server 26. It should be noted that such relaying is a type of data sniffing as discussed above. As will be appreciated by those skilled in the art, the acquisition of data packets is carried out without interfering with normal legacy PoS operation.

The computer 36 may also include a mass storage device 64 to allow the computer 36 to retain large amounts of data permanently. The mass storage device 64 may include all types of disk drives such as floppy disks, hard disks and optical disks, as well as tape drives that can read and write data onto a tape that could include digital audio tapes (DAT), digital linear tapes (DLT), or other magnetically coded media. The above-described computer 36 may take the form of a hand-held digital computer, personal digital assistant computer, notebook computer, personal computer, workstation, mini-computer, mainframe computer or supercomputer.

In the illustrated embodiment, the transaction card data (comprising consumer identification data) embedded in the transaction card is read via the card read/write device 54 upon presentation of the transaction card at the terminal 24. Alternatively, the consumer identification data may be entered into the transaction terminal 24 through other input or peripheral devices 42. Similarly, transaction data (comprising information related to products purchased, number of quantity purchased for each product, cost per piece, and so forth) is entered into the transaction terminal (PoS terminal) either through barcode scanner 56 or other input/peripheral devices 42. The consumer identification data along with transaction data is then transmitted from the transaction terminal 24 to the transaction server 26 over the data pathway 44 and the communication network 60. As will be appreciated by one skilled in the art, the transaction server 26 is configured to receive the consumer identification data and the transaction data from the terminal 24 and capture details of a consumer along with details of the transaction performed by the respective consumer in the transaction database.

Similarly, the promotion subsystem 30 is configured to acquire consumer identification and/or transaction data traversing from the transaction terminal 24 to the transaction server 26 over the communication network 60 or the data pathway 44 through the data acquisition circuitry 62. As noted above, the data acquisition circuitry constantly monitors the PoS communication channel and acquires the data traversing the PoS communication channel by employing any packet sniffing technologies. The promotion subsystem 30 may then decipher the PoS terminal to controller protocol and interpret the details of the acquired data (i.e., transaction in progress) via the processor. Thus, the promotion subsystem 30 obtains information related to consumer identification and transaction details such as product identification, transaction volume and so forth. As will be appreciated by one skilled in the art, the data acquisition is carried out without interfering with normal legacy PoS operations. The promotion subsystem 30 may then generate one or more promotions to be offered to the consumer based on the acquired data (sniffed information) via the processor 38. The promotion subsystem 30 may also access the transaction/promotion history of the consumer from the transaction/promotion database respectively to facilitate the generation of new promotions. The promotion subsystem 30 is further configured to send promotional data comprising one or more promotions to the transaction terminal 24 over the communication network 60 or the data pathway 44 in accordance with aspects of the present technique. Additionally, the one or more generated promotions may be saved in the promotion database for subsequent use or tallying.

The transaction terminal 24 is configured to receive the promotional data from the promotion subsystem 30 and to write the promotional data on the transaction card via the card read/write device 48. Alternatively, the terminal 24 may be configured to extract the one or more promotions from the promotional data via the processor 38 and display or print the extracted promotions via the display device 50 or the printer 52 respectively. In one embodiment, the one or more extracted promotions may be displayed to the consumer as a selectable choice. The selected promotions may then be written on the transaction card via the card read/write device 54 or printed via the printer 46. In one embodiment, the one or more promotions may be immediately redeemed at the transaction terminal. For example, the discount coupons may be printed as barcode that may then be immediately scanned via the barcode scanner to avail the discount. Alternatively, as will be appreciated by those skilled in the art, the one or more promotions may be directly applied to an ongoing transaction. In short, the one or more promotions are printed via a printer coupled to the PoS terminal, written on a transaction card via a card read/write device coupled to the PoS terminal, displayed via a display device coupled to the PoS terminal, or applied to the ongoing transaction.

As will be appreciated by one skilled in the art, the one or more promotions may be customized for each consumer based on consumer's behavior and interest. The promotion subsystem may access the transaction and/or promotion history of the consumer from a transaction and/or promotion database respectively. The promotion subsystem may then perform analysis on each consumer's behavior based on his/her current and/or a past transaction and/or promotion data via an analytics engine to generate the one or more customized promotions. The analysis may be performed periodically or in real time. The customized marketing and promotional offers for a specific consumer can be stored in a promotion database. The promotion subsystem 30 may then send these customized marketing or promotional offers along with various other marketing or promotional offers to the terminal 12 for being written on the transaction card, or displayed on a display device, or printed via a printer, or applied on an ongoing transaction. Additionally, in certain embodiments, the promotion subsystem 30 may maintain a consumer account for each consumer in the promotion database to store the one or more promotions associated with him/her. The consumer may access the associated account online to view the one or more promotions available to him or her through the terminal either via transaction card or via login information (user id and password). The consumer may then select the desired promotions for being availed in real time or during any subsequent transaction. As will be appreciated by one skilled in the art, in certain embodiments, the consumer may use his mobile device or computer terminal to write the selected promotions on his/her transaction card via a card read/write device installed in or coupled to the mobile device or the computer terminal.

As will be appreciated by one skilled in the art, the transaction card may include any card having a data storage medium. For example, the transaction card may include a magnetic stripe card, a RFID card, an optical card, a contact or contactless smart card and so forth. These cards may be used as a debit card, a credit card, a PLCC card, a bank card, a loyalty card (for facilitating loyalty based promotions carried out by a specific retailer or promoter), reward card (for facilitating reward points based promotions generally carried out by a retailer or transaction bank), and so forth. It should be noted that the information such as promotional data may be written on one of the available read/write tracks of the magnetic stripe card. In one embodiment, the available read/write track may be track 2 and/or track 3 of the magnetic stripe card. The promotional data may include one or more promotions such as a discount coupon, a cash back offer, a product discount, a credit card APR discount, a reward point based promotion, a loyalty point based promotion and so forth. Additionally, the one or more promotions may include general information or offers related to product and services such as cross sell offers. As will be appreciated by one skilled in the art, the one or more promotions may be uniquely encoded in a pre-specified format to generate the promotional data via any known or developed encoding schemes before being sent to the terminal.

As will be appreciated by one skilled in the art, a variety of techniques may be employed to deliver promotional or marketing offers to the consumers. In particular, as will be appreciated by those of ordinary skill in the art, control logic and/or automated routines for performing the techniques and steps described herein may be implemented by the system 22, either by hardware, software, or combinations of hardware and software. For example, suitable code may be accessed and executed by the processor 38 to perform some or all of the techniques described herein. Similarly application specific integrated circuits (ASICs) configured to perform some or all of the techniques described herein may be included in the processor 38.

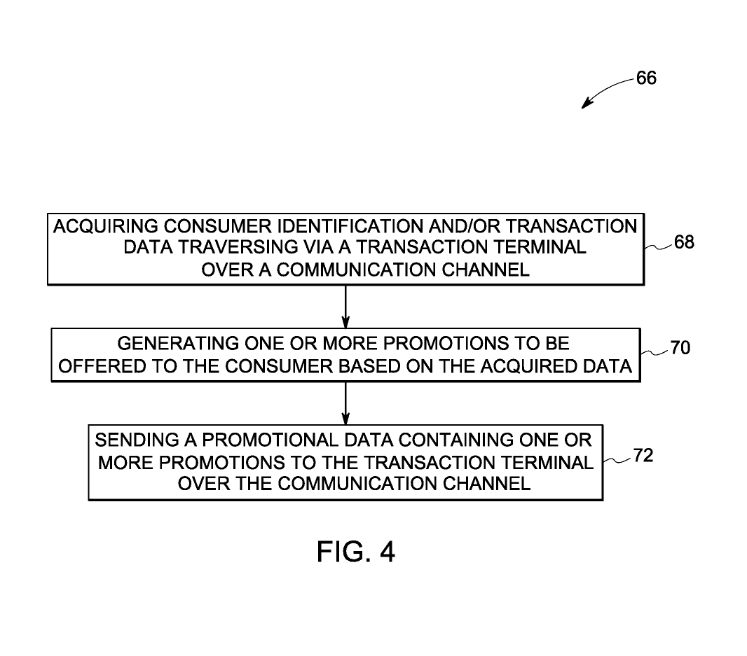

For example, referring now to FIG. 4, exemplary control logic 66 for delivering the promotional or marketing offers to the consumer via a promotion delivery system, such as system 10, is depicted via a flowchart in accordance with aspects of the present technique. As illustrated in the flowchart, the control logic 66 includes the steps of acquiring consumer identification and/or transaction data traversing via a transaction terminal over a communication channel at step 68 and generating one or more promotions to be offered to the consumer based on the acquired data at step 70. The control logic 66 further includes the step of sending a promotional data containing the one or more generated promotions to the transaction terminal over the communication channel at step 72.

The control logic 66 may also include the step of monitoring data traffic over the communication channel so as to acquire consumer identification and/or transaction data upon detecting the data traffic. Additionally, as will be appreciated by those skilled in the art, the control logic 66 may further include the step of printing the one or more promotions via a printer coupled to the transaction terminal, writing the one or more promotions on a transaction card via a card read/write device coupled to the transaction terminal, displaying the one or more promotions via a display device coupled to the transaction terminal, and/or applying the one or more promotions to an ongoing transaction.

As will be appreciated by those skilled in the art, the promotion system and techniques as described in various embodiments discussed above provide an efficient and cost-effective way of delivering and tracking various promotional or marketing offers to the consumer so as to increase the sales and revenue. For example, the availability of promotional offers at the time of processing a transaction will increase the probability of usage of these offers, thereby increasing the volume of transactions and sales revenue. Additionally, the ability to customize promotional offers for each user via the back end analytics system will increase the effectiveness of the promotions. The technique further allows a business entity (retailer) to provide a choice to its customer to select and personalize various offers of interest. This will enhance the capability of business entities to capture consumer preferences and to personalize the promotions based on their preferences for target marketing. Moreover, the techniques enable the consumers to view, select, or use their entitled offers at their convenience resulting in increased effectiveness of the promotions.

Further, as will be appreciated by one skilled in the art, the techniques as described in various embodiments discussed above may be easily integrated with a legacy PoS system, thereby allowing non-intrusive integration of promotion incentives and schemes into a legacy PoS system (conventional PoS system). This in part is enabled by employing passive packet sniffing technologies to acquire the cusumer identification and transaction information. Further, the techniques enable to develop models and algorithms for personalized promotional offers, which can later be easily deployed in the market using the invention. The promotion decision-making algorithms can also be later improved/modified without affecting the functionality of the PoS system. Thus, the technique may form a part of a decision-making system for providing real-time personalized promotions. Additionally, marketing and promotional offers can be in made electronic form, thereby reducing or eliminating the traditional and more expensive print based promotion techniques and wastage associated with them. Moreover, promotional values can be netted against transaction values electronically and immediately.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for delivering promotions to a consumer, the system comprising:
data acquisition circuitry communicatively coupled to a PoS communication channel and configured to acquire consumer identification or transaction data traversing via a PoS terminal; and
a processor configured to generate one or more promotions to be offered to the consumer based on the acquired data.

2. The system of claim 1, wherein the PoS communication channel comprises at least one of a wired communication network, a wireless communication network, and a data pathway.

3. The system of claim 1, wherein the processor is further configured to send a promotional data containing the one or more promotions to the PoS terminal over the PoS communication channel.

4. The system of claim 1, wherein the one or more promotions are printed via a printer coupled to the PoS terminal, written on a transaction card via a card read/write device coupled to the PoS terminal, displayed via a display device coupled to the PoS terminal, or applied to an ongoing transaction.

5. The system of claim 1, wherein the processor is further configured to decipher the PoS terminal to PoS controller protocol and interpret the details of the acquired data.

6. The system of claim 1, wherein the data acquisition circuitry is further configured to monitor data traffic over the communication channel and acquire consumer identification or transaction data upon detecting the data traffic.

7. The system of claim 1, wherein the PoS terminal reads consumer identification data from a transaction card via a transaction card reader.

8. The system of claim 1, wherein the processor is further configured to access a transaction or promotion history of the consumer from a transaction or promotion database respectively.

9. The system of claim 1, wherein the data acquisition circuitry is configured to acquire consumer identification or transaction data via packet sniffing technologies.

10. The system of claim 1, wherein the data acquisition circuitry is configured to acquire consumer identification or transaction data without interfering with normal legacy PoS operation.

11. The system of claim 1, wherein the one or more promotions comprises a discount coupon, a cash back offer, a product discount, a credit card APR discount, a reward point based promotion, or a loyalty point based promotion.

12. The system of claim 1, wherein the one or more promotions are customized for the consumer.

13. The system of claim 12, wherein the processor is further configured to perform an analysis on the consumer behavior based on a current or a past transaction or promotion data to generate the one or more customized promotions.

14. The system of claim 1, wherein the processor is further configured to host a promotion database to store the one or more promotions associated with each consumer.

15. A system for delivering promotions to a consumer, the system comprising:
data acquisition circuitry communicatively coupled to a communication channel between a peripheral device and a transaction terminal or between the transaction terminal and a transaction server, the data acquisition circuitry configured to acquire consumer identification or transaction data traversing over the communication channel; and
a processor configured to generate one or more promotions to be offered to the consumer based on the acquired data.

16. The system of claim 15, wherein the processor is further configured to send a promotional data containing the one or more promotions to the transaction terminal over the communication channel.

17. The system of claim 15, wherein the one or more promotions are printed via a printer coupled to the PoS terminal, written on a transaction card via a card read/write device coupled to the PoS terminal, displayed via a display device coupled to the PoS terminal, or applied to an ongoing transaction.

18. A point of sale (PoS) system, comprising:
a PoS terminal configured to acquire consumer identification or transaction data through one or more peripheral devices and to transfer the acquired data to a PoS controller over a communication channel; and
a promotion subsystem communicatively coupled to the communication channel and configured to acquire the consumer identification or transaction data traversing over the communication channel and to generate one or more promotions to be offered to the consumer based on the acquired data.

19. The PoS system of claim 18, wherein the promotion subsystem is a server coupled to the communication channel.

20. The PoS system of claim 18, wherein the promotion subsystem is a microcontroller coupled to the data pathway of the PoS terminal.

21. The PoS system of claim 18, wherein the promotion subsystem comprises data acquisition circuitry and a processor.

22. A method of delivering promotions to a consumer, the method comprising:
acquiring consumer identification or transaction data traversing via a PoS terminal over a communication channel; and
generating one or more promotions to be offered to the consumer based on the acquired data.

23. The method of claim 22, further comprising sending a promotional data containing one or more promotions to the PoS terminal over the communication channel.

24. The method of claim 22, further comprising printing the one or more promotions via a printer coupled to the PoS terminal, writing the one or more promotions on a transaction card via a card read/write device coupled to the PoS terminal, displaying the one or more promotions via a display device coupled to the PoS terminal, or applying the one or more promotions to an ongoing transaction.

25. The method of claim 22, further comprising monitoring data traffic over the communication channel and acquiring consumer identification or transaction data upon detecting the data traffic.

26. The method of claim 22, wherein generating one or more promotions further comprises accessing a transaction or promotion history of the consumer from a transaction or promotion database respectively.

27. The method of claim 22, further comprising customizing the one or more promotions for the consumer by performing an analysis on the consumer behavior based on a current or a past transaction or promotion data.

28. The method of claim 22, wherein the transaction data comprises information related to products purchased and cost of the respective products.
